(19) United States
(12) Patent Application Publication
(10) Pub. No.: US 2023/0135222 A1
(43) Pub. Date: May 4, 2023

(54) COMPOSITIONS, ARTICLES, DEVICES, AND METHODS RELATED TO DROPLETS COMPRISING A CLOAKING FLUID

(71) Applicant: Massachusetts Institute of Technology, Cambridge, MA (US)

(72) Inventors: Kripa K. Varanasi, Lexington, MA (US); Vishnu Jayaprakash, Cambridge, MA (US); Sreedath Panat, Cambridge, MA (US); Simon B. Rufer, Cambridge, MA (US)

(73) Assignee: Massachusetts Institute of Technology, Cambridge, MA (US)

(21) Appl. No.: 17/975,485

(22) Filed: Oct. 27, 2022

Related U.S. Application Data
(60) Provisional application No. 63/277,958, filed on Nov. 10, 2021.
(60) Provisional application No. 63/273,500, filed on Oct. 29, 2021.

(51) Int. Cl. A01N 25/24; B01J 13/04; A01P 15/00

(52) U.S. Cl. CPC A01N 25/24; A01P 15/00; B01J 13/043

(57) ABSTRACT

Described herein are compositions and articles related to droplets comprising a carrier fluid and a cloaking fluid, and associated methods of and devices for depositing the droplets on surfaces.

### RELATED APPLICATIONS

This application claims the benefit of priority under 35 U.S.C. § 119(e) of U.S. Provisional Application No. 63/273,500, filed Oct. 29, 2021, and U.S. Provisional Application No. 63/277,958, filed Nov. 10, 2021, the disclosures of which are incorporated herein by reference in their entirety.

### TECHNICAL FIELD

Described herein are compositions and articles related to droplets comprising a carrier fluid and a cloaking fluid, and associated methods of and devices for depositing the droplets on surfaces.

### BACKGROUND

Pesticide pollution causes more than 20,000 deaths a year globally and is linked to up to 385 million cases of acute illnesses-which includes diseases like cancer, neurological conditions, and birth defects. Pesticides pollute all parts of the environment, especially water and soil. For example, pesticides are detected 90% of the time in agricultural streams, 50% of the time in shallow wells, and 33% of the time in major deep aquifers across the United States. A recent study has shown that 31% of all global agricultural soil is at high risk of pesticide pollution. These excess pesticides not only affect soil chemistry but also cause the death of non-target organisms and damage soil microbiomes that are responsible for replenishing plant nutrients in the soil. In addition to having a heavy human and environmental cost, pesticides represent a major financial burden for farmers, who spend over sixty billion dollars a year in pesticides globally as they can contribute to -30% of the production costs for certain crops, such as cotton. There is therefore an urgent need to reduce pesticide waste and overuse.

### SUMMARY

Described herein are compositions and articles related to droplets comprising a carrier fluid and a cloaking fluid, and associated methods of and devices for depositing the droplets on surfaces. The subject matter of the present invention involves, in some cases, interrelated products, alternative solutions to a particular problem, and/or a plurality of different uses of one or more systems and/or articles.

According to some embodiments, a composition is described, the composition comprising a carrier fluid, a cloaking fluid, and one or more species for delivery to a surface of a substrate, wherein the cloaking fluid is configured to at least partially surround the carrier fluid while the composition is applied to the surface of the substrate.

In certain embodiments, a composition comprises a carrier fluid, a cloaking fluid surrounding the carrier fluid, and one or more species for delivery to a surface of a substrate, wherein a spreading coefficient of the composition is greater than or equal to 0, wherein the spreading coefficient is defined by:

$$S = {σ}_{w a t e r + s p e c i e s , a i r} - \left({σ}_{w a t e r + s p e c i e s , c l o a k i n g f l u i d} + {σ}_{c l o a k i n g f l u i d , a i r}\right) ,$$

wherein σ is an interfacial tension.

In some embodiments, a composition comprises a carrier fluid, a cloaking fluid at least partially surrounding the carrier fluid, and one or more species for delivery to a surface of a substrate, wherein the composition comprises the cloaking fluid in an amount less than or equal to 5% by volume versus the total volume of the composition.

According to certain embodiments, a composition comprises a carrier fluid, a plurality of cloaking fluids at least partially surrounding the carrier fluid, and one or more species for delivery to a surface of a substrate, wherein the composition comprises the plurality of cloaking fluids in an amount less than or equal to 5% by volume versus the total volume of the composition.

In some embodiments, an article is described, the article comprising a substrate comprising a surface, and a droplet deposited on the surface, wherein the droplet comprises a carrier fluid, a cloaking fluid at least partially surrounding the carrier fluid, and one or more species for delivery to the surface of the substrate.

In certain embodiments, a method of depositing a droplet on a surface of a substrate is described, the method comprising: exposing a carrier fluid to a cloaking fluid; at least partially surrounding the carrier fluid in the cloaking fluid, thereby forming the droplet, wherein the droplet comprises the cloaking fluid in an amount less than or equal to 5% by volume versus the total volume of the droplet, and the droplet comprises one or more species for delivery to the surface of the substrate; and depositing the droplet on the surface of the substrate.

According to some embodiments, a device is described, the device comprising a first compartment containing a carrier fluid, a second compartment containing a cloaking fluid, and one or more species for delivery to a surface of a substrate, wherein the device is configured to expose the carrier fluid to the cloaking fluid such that the cloaking fluid at least partially surrounds the carrier fluid, thereby providing a composition comprising the cloaking fluid in an amount less than or equal to 5% by volume versus the total volume of the composition.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, according to certain embodiments, a cross-sectional schematic diagram of a droplet comprising a carrier fluid and a cloaking fluid at least partially surrounding the carrier fluid, wherein the carrier fluid includes a species;

FIG. 1B shows, according to certain embodiments, a cross-sectional schematic diagram of a droplet comprising a carrier fluid and a cloaking fluid at least partially surrounding the carrier fluid, wherein the cloaking fluid includes a species;

FIG. 1C shows, according to certain embodiments, a cross-sectional schematic diagram of a droplet comprising a carrier fluid and a cloaking fluid at least partially surrounding the carrier fluid, wherein the carrier fluid and the cloaking fluid include a species;

FIG. 1D shows, according to certain embodiments, a cross-sectional schematic diagram of a droplet comprising a carrier fluid and a cloaking fluid partially surrounding the carrier fluid;

FIG. 2 shows, according to certain embodiments, a cross-sectional schematic diagram of a droplet comprising a carrier fluid and a plurality of cloaking fluids at least partially surrounding the carrier fluid;

FIG. 3A shows, according to certain embodiments, a cross-sectional schematic diagram of a droplet comprising a carrier fluid and a cloaking fluid at least partially surrounding the carrier fluid, wherein the droplet is deposited onto a surface of a substrate, and wherein the carrier fluid includes a species and the cloaking fluid is in contact with the surface;

FIG. 3B shows, according to certain embodiments, a cross-sectional schematic diagram of a droplet comprising a carrier fluid and a cloaking fluid partially surrounding the carrier fluid, wherein the droplet is deposited onto a surface of a substrate, and wherein the carrier fluid includes a species and the carrier fluid is in contact with the surface;

FIG. 3C shows, according to certain embodiments, a cross-sectional schematic diagram of a droplet comprising a carrier fluid and a cloaking fluid partially surrounding the carrier fluid, wherein the droplet is deposited onto a surface of a substrate, and wherein the carrier fluid includes a species and both the carrier fluid and the cloaking fluid are in contact with the surface;

FIGS. 4A-4D show, according to certain embodiments, a method of depositing a droplet on a surface of a substrate;

FIG. 5A shows, according to certain embodiments, a device comprising a nozzle for delivering a droplet comprising a carrier fluid and a cloaking fluid at least partially surrounding the carrier fluid, wherein the carrier fluid includes a species;

FIG. 5B shows, according to certain embodiments, a device comprising two nozzles configured to generate a droplet comprising a carrier fluid and a cloaking fluid at least partially surrounding the carrier fluid, wherein the carrier fluid includes a species;

FIG. 6A shows, according to certain embodiments, a schematic diagram of water sprayed onto leaves (left) and time-lapse images of water sprayed onto a cabbage leaf for three seconds (right);

FIG. 6B shows, according to certain embodiments, a schematic diagram of oil-cloaked water droplets sprayed onto leaves (left) and time-lapse images of water droplets cloaked with ~1 vol.% soybean oil sprayed onto a cabbage leaf for one second (right);

FIG. 7 shows, according to certain embodiments, droplet coverage expressed as a percentage of total leaf area and normalized by spray time;

FIG. 8A shows, according to certain embodiments, a schematic of an experimental setup used to study the impact of a water droplet (left) and time-lapse images of the impact of a water droplet from side (top) and top-down (bottom) views (right);

FIG. 8B shows, according to certain embodiments, a schematic of an experimental setup used to study the impact of a water droplet cloaked with oil (left) and time-lapse images of the impact of a water droplet cloaked with 1% vol. soybean oil from side (top) and top-down (bottom) views (right);

FIG. 9A shows, according to certain embodiments, a plot of the normalized contact diameter as a function of time for seven different oil cloaks with an impact velocity ≈ 1.25 m/s;

FIG. 9B shows, according to certain embodiments, a plot of the normalized maximum diameter as a function of the correlation function f (Re,We);

FIG. 9C shows, according to certain embodiments, a plot of the rebound height of the center of mass of droplets (h_{cm}) normalized by droplet diameter (D) for different impact velocities, oils, and oil viscosities;

FIG. 9D shows, according to certain embodiments, a plot of the rebound height of the center of mass of droplets (h_{cm}) normalized by droplet diameter (D) for different impact experiments plotted as a function of oil volume fraction in cloaked droplets;

FIG. 10 shows, according to certain embodiments, a plot of the average dynamic contact angle measured during the retraction phase for water droplets cloaked in 10 cSt silicone oil at low oil volume fractions (left) and snapshots taken during the retraction of oil cloaked droplets with 0.10% (top right) and 0.03% (bottom right) oil by volume;

FIG. 11 shows, according to certain embodiments, snapshots of the highest points of the centers of mass of droplets during retraction or rebound for selected experiments;

FIG. 12A shows, according to certain embodiments, a schematic depicting a water droplet rebounding from a superhydrophobic surface, wherein the upward arrow indicates its motion away from the surface and the water droplet has a kinetic energy that can be expressed in terms of the coefficient of restitution (e₀), the rebound velocity (v), and the mass of the droplet (m);

FIG. 12B shows, according to certain embodiments, a schematic depicting a water droplet cloaked in oil sticking to a surface, wherein the kinetic energy is removed from the droplet by the work of adhesion (Eₛ) and viscous dissipation (Eµ_{I} + Eµ_{II} + Eµ_{III});

FIG. 12C shows, according to certain embodiments, a plot of the ratio of the kinetic energy of rebound of a pure water droplet and sum of the work of adhesion and the viscous dissipation as a function of droplet velocity;

FIG. 13A shows, according to certain embodiments, advancing and receding contact angles of only water or only oil on a superhydrophobic surface;

FIG. 13B shows, according to certain embodiments, advancing and receding contact angles of water droplets cloaked with 1 vol.% oil;

FIG. 14A shows, according to certain embodiments, an image of the result of spraying a superhydrophobic wafer with pure water for 3 seconds;

FIG. 14B shows, according to certain embodiments, an image of the result of spraying a superhydrophobic wafer with water cloaked with 1 vol.% soybean oil;

FIG. 14C shows, according to certain embodiments, a plot of the retained mass of droplets on a superhydrophobic surface for different spray times and different oil cloaks;

FIG. 14D shows, according to certain embodiments, snapshots of the coverage attainable with 1 second of spraying with soybean oil-cloaked water droplets on (a) cabbage, (b) kale, (c) lettuce and (d) spinach leaves; and

FIG. 14E shows, according to certain embodiments, a plot of the mass of droplets retained on the leaf normalized by leaf area and spray time compared on 4 crop leaves for pure water and soybean oil cloaked water droplets cloaked with 1 vol.% soybean oil.

### DETAILED DESCRIPTION

A major source of pesticide waste and resultant overuse is caused by poor spray or droplet retention on hydrophobic plant surfaces. The waxy coatings on plant surfaces (e.g., leaves) yield hydrophobic surface properties which present a fundamental barrier to pesticide retention, as pesticide sprays consist of pesticide molecules dissolved or suspended in water droplets. As a result, the water droplets bounce and/or roll off the plant surfaces, causing a large majority of what is sprayed to find its way into water and soil in the environment.

In agricultural sprays, droplet sizes range from 50-600 µm and droplet impact velocities range from 1-8 m/s, which corresponds to a Weber number range of 1-600. During impact, such droplets undergo expansion driven by inertial forces and retraction that is driven by surface tension. Whether the droplet sticks or bounces is determined by surface properties, such as surface energy and leaf micro-texture, and droplet properties, such as surface tension, viscosity, density, and impact velocity. Conventional methods to increase droplet retention on plant surfaces include using: (i) adjuvants to modify droplet properties such as surface tension, viscosity, or density; (ii) additives that can disrupt the waxy coatings on leaf surfaces locally and promote adhesion; (iii) chemicals that generate microscopic pinning sites for droplets to stick; or (iv) physical charged interactions to promote droplet adhesion.

Surfactants are the most widely used adjuvants that aim to enhance spray coverage and retention. While their effect on improving the spreading of droplets on plant surfaces under static conditions is well documented, their ability to suppress the rebound of impacting droplets is more complex. Only specialized surfactants can diffuse to the droplet interface fast enough to reduce the dynamic surface tension of droplets during impact and arrest rebound. In addition, surfactants suffer from a lack of universality as they must be chemically stable with a diverse range of pesticide chemistries. As they reduce surface tension, they also make sprayed droplets smaller which exacerbates pesticide drift and environmental pollution. Finally, some surfactants that are used commercially can be more environmentally and biologically toxic than the active ingredients in the pesticides. For example, the addition of fatty amine ethoxylate surfactants to Roundup® make these formulations cause more mitochondrial damage and necrosis in human cells, and such surfactants are much more toxic towards amphibian populations than the active ingredient, glyphosate, alone.

Viscosity modifying adjuvants that utilize viscous dissipation during impact to prevent the droplets from bouncing off plant surfaces offer limited improvement to spray retention efficiency on plant surfaces. High molecular weight polymer-based adjuvants that can significantly enhance the extensional rheology of droplets have also been shown to slightly enhance spray retention (e.g., ~2% enhancement on leaf surfaces). In addition to their moderate improvement, the need for the careful control of pH for such formulations presents a significant barrier to robust implementation. Furthermore, electrostatic sprayers that physically charge spray droplets and introduce an attractive force towards grounded plant surfaces suffer from high costs that limit applicability.

Unlike the above approaches, which are either unsustainable, toxic, non-universal or expensive, plant-based oils hold great promise as adjuvants that can promote droplet retention. Oils have been used in agriculture for centuries as they possess insecticidal and fungistatic properties. Vegetable oils are generally recognized as safe, are understood to pose no risks to the environment, and are widely used in food products and in agriculture. Since they are readily degradable by microbes in the soil, these oils have a much lower environmental footprint than synthetic agrochemicals. Their impact on crop health is well understood, and they are not phytotoxic when used correctly. Some oils are more robust against resistance development in pests, and some plant oils have minimal impact on non-target insects like honeybees. As spray adjuvants, the lower surface energy of oils makes them stick more easily to hydrophobic leaves as compared to water. Oils are predominantly formulated as oil-in-water emulsions, necessitating the use of surfactants-which have the drawbacks mentioned above-and the need for complex agitation methods at the point of use. In comparison to oil-in-water emulsions, water-in-oil emulsions (>10% oil by volume) have the potential for phytotoxicity, as such large oil contents limit the applicability of such formulations.

The inventors have realized and appreciated that compositions comprising a droplet of a carrier fluid surrounded by minute quantities (e.g., less than or equal to 5% by volume) of a cloaking fluid may be used to enhance droplet retention on substrate surfaces (e.g., agricultural surfaces such as leaves). In some embodiments, the carrier fluid may comprise water and the cloaking fluid may comprise an oil, such as a food and environmentally safe plant-based oil. By leveraging oil-water wetting dynamics and surface tensions, the oil may be introduced after forming the water droplet, thereby avoiding the complexities of emulsification or the use of environmentally harmful surfactants.

The cloaked droplets described herein offer a simple, environmentally sustainable, inexpensive, and effective approach to enhance the retention of sprays (e.g., pesticide sprays) on hydrophobic surfaces. The inventors have demonstrated that the methodology described herein provides robust rebound suppression on hydrophobic surfaces with a variety of different cloaking fluids that span a wide range of viscosities and surface tensions across agriculturally relevant impact conditions. The amount of cloaking fluid to achieve rebound suppression can be advantageously low (e.g., as little as 0.1 vol%), thereby avoiding the possibility of phytotoxicity. Devices (e.g., sprayer devices) are also described herein, which can be used to spray the cloaked droplets onto hydrophobic substrate surfaces and provide an enhancement in droplet retention, leading to a significant reduction in waste. As explained herein, the enhancements in droplet retention have been achieved using food and environmentally safe carrier fluids and cloaking fluids (e.g., water and oil, respectively), thereby demonstrating great promise in reducing the human health and environmental impact of pesticides.

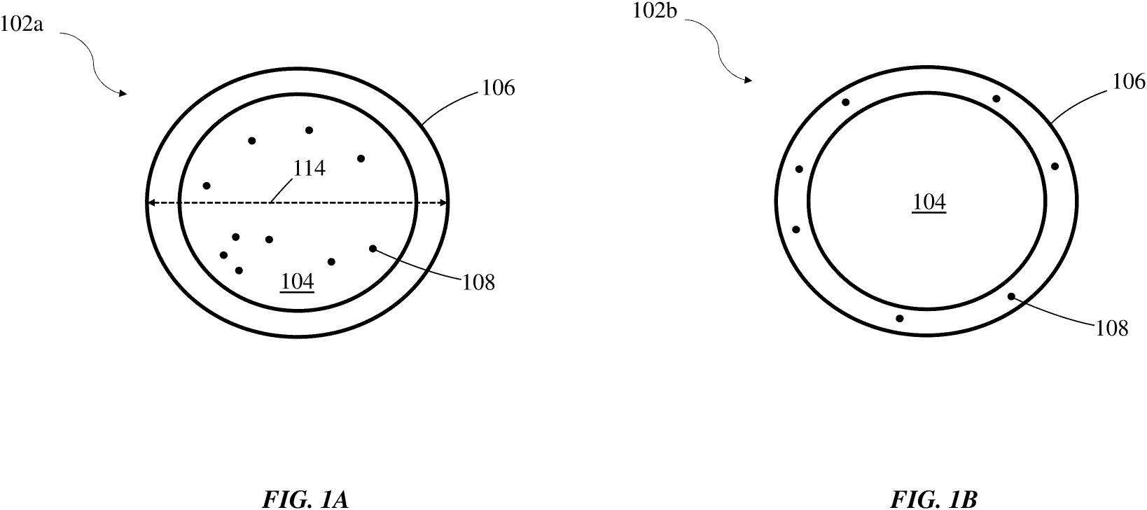

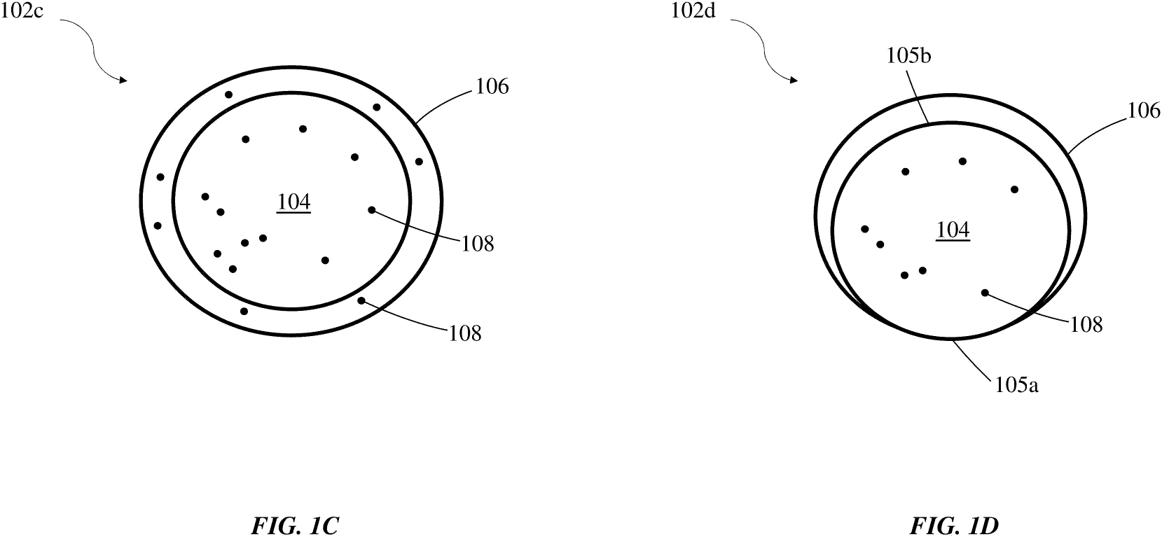

According to some embodiments, a composition is described herein. The composition may comprise a carrier fluid, in certain embodiments. As used herein, the term “carrier fluid” generally refers to a fluid capable of transporting one or more species. In certain embodiments, for example, and as will be explained in further detail below, the carrier fluid may include a species for delivery to a surface of a substrate. FIG. 1A shows, according to certain embodiments, a cross-sectional schematic diagram of a droplet. Referring to FIG. 1A, composition 102a (e.g., droplet) comprises carrier fluid 104, wherein carrier fluid 104 includes species 108.

Any of a variety of suitable carrier fluids may be utilized. In some embodiments, for example, the carrier fluid comprises water, an aqueous solution, an oil, and/or a non-Newtonian fluid. Other carrier fluids are also possible. In some embodiments, a mixture of carrier fluids may be utilized (e.g., a mixture of water and a non-Newtonian fluid).

The composition may comprise the carrier fluid in any of a variety of suitable amounts. According to some embodiments, the composition comprises a relatively high amount of the carrier fluid. In certain embodiments, for example, the composition comprises the carrier fluid in amount greater than or equal to 95% by volume, greater than or equal to 96% by volume, greater than or equal to 97% by volume, greater than or equal to 98% by volume, greater than or equal to 99% by volume, greater than or equal to 99.1% by volume, greater than or equal to 99.2% by volume, greater than or equal to 99.3% by volume, greater than or equal to 99.4% by volume, greater than or equal to 99.5% by volume, greater than or equal to 99.6% by volume, greater than or equal to 99.7% by volume, or greater than or equal to 99.8% by volume versus the total volume of the composition. In some embodiments, the composition comprises the carrier fluid in an amount less than or equal to 99.9% by volume, less than or equal to 99.8% by volume, less than or equal to 99.7% by volume, less than or equal to 99.6% by volume, less than or equal to 99.5% by volume, less than or equal to 99.4% by volume, less than or equal to 99.3% by volume, less than or equal to 99.2% by volume, less than or equal to 99.1% by volume, less than or equal to 99% by volume, less than or equal to 98% by volume, less than or equal to 97% by volume, or less than or equal to 96% by volume versus the total volume of the composition. Combinations of the above recited ranges are possible (e.g., the composition comprises the carrier fluid in an amount greater than or equal to 95% by volume and less than or equal to 99.9% by volume versus the total volume of the composition, the composition comprises the carrier fluid in an amount greater than or equal to 99% by volume and less than or equal to 99.5% by volume versus the total volume of the composition). Other ranges are also possible. In some embodiments, the amount of the carrier fluid may be determined by imaging the droplets using a microscopic lens, micro-spectroscopy, or nuclear magnetic resonance (NMR). In certain embodiments, the amount of the carrier fluid may be determined by analyzing the input flow rate of the carrier fluid used to generate the composition.

According to some embodiments, the composition comprises a cloaking fluid. As used herein, the term “cloaking fluid” generally refers to a first fluid that is configured to at least partially surround a second fluid such that a layer of the first fluid spreads over and at least partially surrounds the second fluid. In certain embodiments, for example, the cloaking fluid is configured to at least partially surround the carrier fluid. In some embodiments, the cloaking fluid at least partially surrounds the carrier fluid (e.g., while the composition is applied to a surface, as explained in further detail herein). Referring, for example, to FIG. 1A, composition 102a comprises cloaking fluid 106 at least partially surrounding carrier fluid 104.

In certain embodiments, the presence of the cloaking fluid (e.g., at least partially surrounding the carrier fluid) may advantageously enhance retention of the composition when disposed (e.g., sprayed) on a surface of a substrate. In some embodiments, for example, the cloaking fluid may be configured to pin the composition to the surface of the substrate during retraction of the composition, for example, as the composition is disposed (e.g., sprayed) on the surface of the substrate.

Any of a variety of suitable cloaking fluids may be utilized. In some embodiments, for example, the cloaking fluid comprises an oil, a surfactant, an aqueous solution, and/or a non-Newtonian fluid. In some embodiments wherein the cloaking fluid comprises an oil, the oil may be a plant-based oil and/or a petroleum-based oil. Although virtually any oil may be utilized, non-limiting examples of suitable oils include soybean oil, canola oil, silicone oil, mineral oil, linseed oil, cotton seed oil, anise oil, bergamot oil, castor oil, cedarwood oil, citronella oil, eucalyptus oil, jojoba oil, lavandin oil, lemongrass oil, methyl salicylate oil, mint oil, mustard oil, and/or orange oil. Other cloaking fluids are also possible. According to some embodiments, a mixture of cloaking fluids may be utilized (e.g., a mixture of oil and a non-Newtonian fluid, a mixture of oils, etc.).

The cloaking fluid may have any of a variety of suitable viscosities. In some embodiments, for example, the cloaking fluid has a viscosity greater than or equal to 1 cSt, greater than or equal to 25 cSt, greater than or equal to 50 cSt, greater than or equal to 75 cSt, greater than or equal to 100 cSt, greater than or equal to 150 cSt, greater than or equal to 200 cSt, greater than or equal to 250 cSt, greater than or equal to 300 cSt, greater than or equal to 350 cSt, greater than or equal to 400 cSt, or greater than or equal to 450 cSt. In certain embodiments, the cloaking fluid has a viscosity less than or equal to 500 cSt, less than or equal to 450 cSt, less than or equal to 400 cSt, less than or equal to 350 cSt, less than or equal to 300 cSt, less than or equal to 250 cSt, less than or equal to 200 cSt, less than or equal to 150 cSt, less than or equal to 100 cSt, less than or equal to 75 cSt, less than or equal to 50 cSt, or less than or equal to 25 cSt. Combinations of the above recited ranges are possible (e.g., the cloaking fluid has a viscosity greater than or equal to 1 cSt and less than or equal to 500 cSt, the cloaking fluid has a viscosity greater than or equal to 50 cSt and less than or equal to 75 cSt). Other ranges are also possible.

The cloaking fluid may have any of a variety of suitable surface tensions. In some embodiments, for example, the cloaking fluid has a surface tension greater than or equal to 1 mN/m, greater than or equal to 5 mN/m, greater than or equal to 10 mN/m, greater than or equal to 15 mN/m, greater than or equal to 20 mN/m, greater than or equal to 25 mN/m, greater than or equal to 30 mN/m, greater than or equal to 35 mN/m, greater than or equal to 40 mN/m, or greater than or equal to 45 mN/m. In certain embodiments, the cloaking fluid has a surface tension less than or equal to 50 mN/m, less than or equal to 45 mN/m, less than or equal to 40 mN/m, less than or equal to 35 mN/m, less than or equal to 30 mN/m, less than or equal to 25 mN/m, less than or equal to 20 mN/m, less than or equal to 15 mN/m, less than or equal to 10 mN/m, or less than or equal to 5 mN/m. Combinations of the above recited ranges are possible (e.g., the cloaking fluid has a surface tension greater than or equal to 1 mN/m and less than or equal to 50 mN/m, the cloaking fluid has a surface tension greater than or equal to 20 mN/m and less than or equal to 25 mN/m). Other ranges are also possible.

The composition may comprise the cloaking fluid in any of a variety of suitable amounts. In certain embodiments, the composition comprises a substantially low amount of the cloaking fluid. According to certain embodiments, it may be advantageous to employ a low amount of the cloaking fluid to avoid the potential for phytotoxic compositions. In some embodiments, for example, the composition comprises the cloaking fluid in an amount less than or equal to 5% by volume, less than or equal to 4% by volume, less than or equal to 3% by volume, less than or equal to 2% by volume, less than or equal to 1% by volume, less than or equal to 0.9% by volume, less than or equal to 0.8% by volume, less than or equal to 0.7% by volume, less than or equal to 0.6% by volume, less than or equal to 0.5% by volume, less than or equal to 0.4% by volume, less than or equal to 0.3% by volume, less than or equal to 0.2% by volume, less than or equal to 0.1% by volume, less than or equal to 0.05% by volume, or less than or equal to 0.04% by volume versus the total volume of the composition. In certain embodiments, the composition comprises the cloaking fluid in an amount greater than or equal to 0.02% by volume, greater than or equal to 0.04% by volume, greater than or equal to 0.05% by volume, greater than or equal to 0.1% by volume, greater than or equal to 0.2% by volume, greater than or equal to 0.3% by volume, greater than or equal to 0.4% by volume, greater than or equal to 0.5% by volume, greater than or equal to 0.6% by volume, greater than or equal to 0.7% by volume, greater than or equal to 0.8% by volume, greater than or equal to 0.9% by volume, greater than or equal to 1% by volume, greater than or equal to 2% by volume, greater than or equal to 3% by volume, or greater than or equal to 4% by volume versus the total volume of the composition. Combinations of the above recited ranges are possible (e.g., the composition comprises the cloaking fluid in an amount greater than or equal to 0.02% by volume and less than or equal to 5% by volume versus the total volume of the composition, the composition comprises the cloaking fluid in an amount greater than or equal to 0.5% by volume and less than or equal to 1% by volume versus the total volume of the composition). Other ranges are also possible. In some embodiments, the amount of the cloaking fluid may be determined by imaging the droplets using a microscopic lens, micro-spectroscopy, or nuclear magnetic resonance (NMR). In certain embodiments, the amount of the cloaking fluid may be determined by analyzing the input flow rate of the cloaking fluid used to generate the composition.

The composition (e.g., droplet) may have any of a variety of suitable shapes. In some embodiments, for example, and as shown in FIG. 1A, composition 102a (e.g., droplet) may be substantially spherical. In other embodiments, the composition may be non-spherical, as the disclosure is not meant to be limiting in this regard. The composition may have any of a variety of suitable sizes. In certain embodiments, for example, and as shown in FIG. 1A, composition 102a (e.g., droplet) may have a maximum characteristic dimension (e.g., a maximum diameter) 114. According to some embodiments, the composition may have a maximum characteristic dimension greater than or equal to 100 micrometers, greater than or equal to 200 micrometers, greater than or equal to 300 micrometers, greater than or equal to 400 micrometers, greater than or equal to 500 micrometers, greater than or equal to 1 mm, greater than or equal to 2 mm, greater than or equal to 3 mm, or greater than or equal to 4 mm. In certain embodiments, the composition may have a maximum characteristic dimension less than or equal to 5 mm, less than or equal to 4 mm, less than or equal to 3 mm, less than or equal to 2 mm, less than or equal to 1 mm, less than or equal to 500 micrometers, less than or equal to 400 micrometers, less than or equal to 300 micrometers, or less than or equal to 200 micrometers. Combinations of the above recited ranges are possible (e.g., the composition has a maximum characteristic dimension greater than or equal to 100 micrometers and less than or equal to 5 mm, the composition has a maximum characteristic dimension greater than or equal to 500 micrometers and less than or equal to 1 mm). Other ranges are also possible. In certain embodiments, the maximum characteristic dimension of the composition may be determined by scanning electron microscopy (SEM) and/or transmission electron microscopy (TEM).

According to certain embodiments, the composition comprises one or more species for delivery to a surface of a substrate. Referring, for example, to FIG. 1A, composition 102a comprises carrier fluid 104, cloaking fluid 106 at least partially surrounding carrier fluid 104, and species 108. In some embodiments, the species may be at least partially dissolved and/or suspended in the carrier fluid, as shown in FIG. 1A. In other embodiments, the species may be at least partially dissolved and/or suspended in the cloaking fluid. For example, FIG. 1B shows, according to certain embodiments, a cross-sectional schematic diagram of composition 102b (e.g., droplet) comprising carrier fluid 104 and cloaking fluid 106 at least partially surrounding carrier fluid 104, wherein cloaking fluid 106 includes species 108 dissolved and/or suspended in cloaking fluid 106. In yet other embodiments, the species may be at least partially dissolved and/or suspended in both the carrier fluid and the cloaking fluid. For example, FIG. 1C shows, according to certain embodiments, a cross-sectional schematic diagram of composition 102c (e.g., droplet) comprising carrier fluid 104 and cloaking fluid 106 at least partially surrounding carrier fluid 104, wherein both carrier fluid 104 and cloaking fluid 106 include species 108, which may be dissolved and/or suspended in carrier fluid 104 and cloaking fluid 106.

According to certain embodiments, the composition may comprise more than one species (e.g., two species, three species, four species, five species, etc.). In some embodiments, for example, the composition may comprise more than one species dissolved and/or suspended in the carrier fluid and/or the cloaking fluid. In certain embodiments, the composition may comprise at least one species dissolved and/or suspended in the carrier fluid and at least one species dissolved and/or suspended in the cloaking fluid. In other embodiments, the composition may comprise at least a first species and a second species dissolved and/or suspended in the carrier fluid. In yet other embodiments, the composition may comprise at least a first species and a second species dissolved and/or suspended in the cloaking fluid.

Any of a variety of suitable species may be utilized. In some embodiments, the species is an agricultural chemical. In certain embodiments, the species is a pesticide, fertilizer, agrochemical compound, and/or surfactant. Non-limiting examples of species include an insecticide, herbicide, fungicide, weedicide, and/or foliar fertilizer. Other species are also possible.

According to some embodiments, the composition may have a spreading coefficient defined by:

$$S = {σ}_{w a t e r + s o l u t e , a i r} - \left({σ}_{w a t e r + s o l u t e , c l o a k i n g f l u i d} + {σ}_{c l o a k i n g f l u i d , a i r}\right) ,$$

wherein σ is an interfacial tension.

In some embodiments, the composition may be configured such that spreading coefficient is greater than or equal to 0. In some such embodiments, the cloaking fluid may completely surround the carrier fluid (i.e., the cloaking fluid covers 100% of the surface area of the carrier fluid). Referring, for example, to FIGS. 1A-1C, cloaking fluid 106 completely surrounds carrier fluid 104.

In certain embodiments, the composition may be configured such that the spreading coefficient is less than 0. In some such embodiments, the cloaking fluid may partially surround the carrier fluid. FIG. 1D shows, according to certain embodiments, a cross-sectional schematic diagram of composition 102d (e.g., droplet) comprising carrier fluid 104 and cloaking fluid 106 partially surrounding carrier fluid 104. In some embodiments, for example, surface 105a of carrier fluid 104 may be an interface between carrier fluid 104 and an external medium (e.g., air, a surface, etc.), while surface 105b of carrier fluid 104 is an interface between carrier fluid 104 and cloaking fluid 106. Although FIG. 1D shows that species 108 is dissolved and/or suspended in carrier fluid 104, as explained above, cloaking fluid 106 may include species 108 in addition to or instead of carrier fluid 104 including species 108.

The cloaking fluid may surround any of a variety of suitable surface areas of the carrier fluid. In certain embodiments, for example, the cloaking fluid surrounds greater than or equal to 50%, greater than or equal to 60%, greater than or equal to 70%, greater than or equal to 80%, greater than or equal to 90%, greater than or equal to 95%, or greater than or equal to 99% of the surface area of the carrier fluid. In some embodiments, the cloaking fluid surrounds less than or equal to 100%, less than or equal to 99%, less than or equal to 95%, less than or equal to 90%, less than or equal to 80%, less than or equal to 70%, or less than or equal to 60% of the surface area of the carrier fluid. Combinations of the above recited ranges are possible (e.g., the cloaking fluid surrounds greater than or equal to 50% and less than or equal to 100% of the surface area of the carrier fluid, the cloaking fluid surrounds greater than or equal to 70% and less than or equal to 80% of the surface area of the carrier fluid). Other ranges are also possible. The surface area of the carrier fluid surrounded by the cloaking fluid may be determined using methods such as SEM and/or TEM.

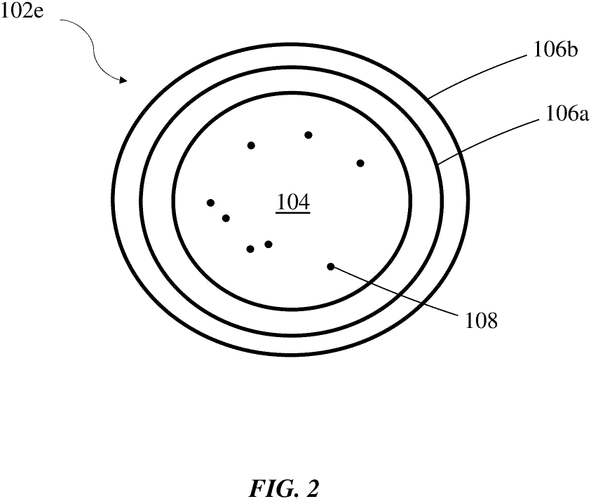

According to some embodiments, the composition may comprise a plurality of cloaking fluids at least partially surrounding the carrier fluid. FIG. 2 shows, in some embodiments, a cross-sectional schematic diagram of composition 102e (e.g., droplet) comprising carrier fluid 104 and a plurality of cloaking fluids 106 (e.g., first cloaking fluid 106a and second cloaking fluid 106b) at least partially surrounding carrier fluid 104. Although FIG. 2 shows a first cloaking fluid and a second cloaking fluid, additional cloaking fluids are also possible (e.g., a third cloaking fluid, a fourth cloaking fluid, a fifth cloaking fluid, etc.), as the disclosure is not meant to be limiting in this regard. In some embodiments, first cloaking fluid 106a may at least partially surround carrier fluid 104, and second cloaking fluid 106b may at least partially surround first cloaking fluid 106a.

Although FIG. 2 shows that species 108 is dissolved and/or suspended in carrier fluid 104, first cloaking fluid 106a and/or second cloaking fluid 106b may include species 108 in addition to or instead of carrier fluid 104 including species 108, as the disclosure in not meant to be limiting in this regard.

According to certain embodiments, and as shown in FIG. 2, first cloaking fluid 106a may completely surround carrier fluid 104, and second cloaking fluid 106b may completely surround first cloaking fluid 106a. In some embodiments, although not shown in the figures, the first cloaking fluid may partially surround the carrier fluid such that a surface of the carrier fluid is an interface between the carrier fluid and the second cloaking fluid. In other embodiments, the second cloaking fluid may partially surround the first cloaking fluid such that a surface of the first cloaking fluid is an interface between the first cloaking fluid and an external medium (e.g., air, a surface, etc.). In yet other embodiments, both the first cloaking fluid and the second cloaking fluid partially surround the carrier fluid such that a surface of the carrier fluid is an interface between the carrier fluid and an external medium (e.g., air, a surface, etc.).

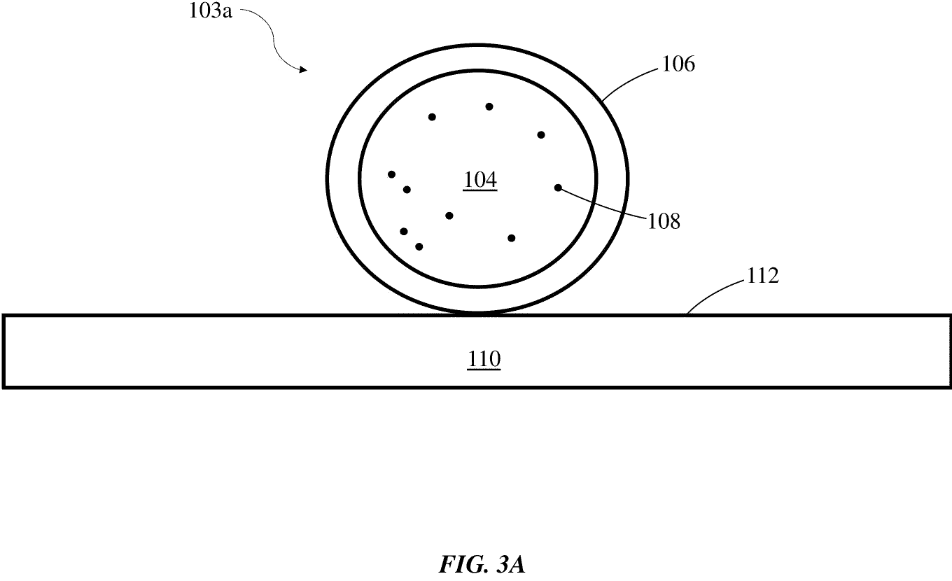

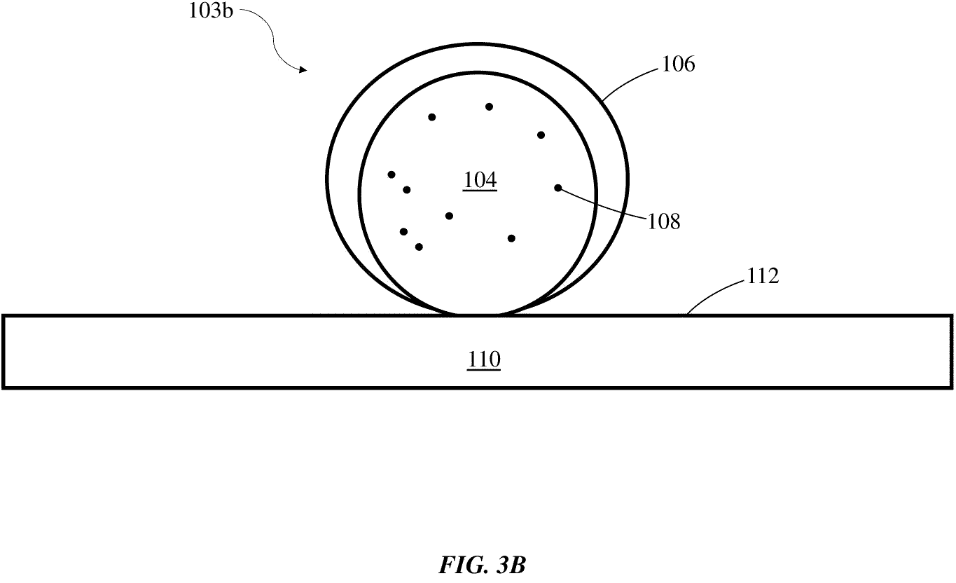

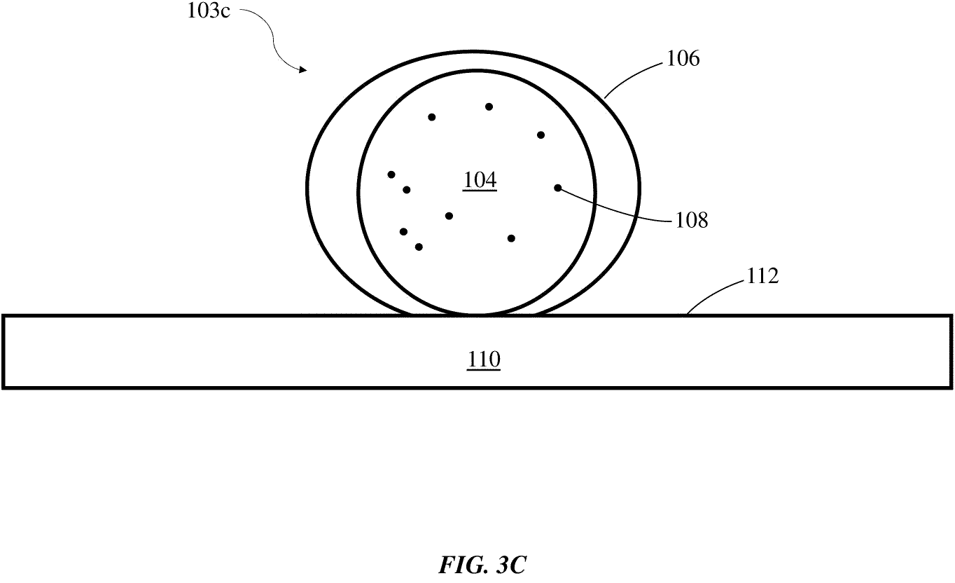

In certain embodiments, an article is described. For example, FIG. 3A shows, according to certain embodiments, a cross-sectional schematic diagram of article 103a comprising a droplet comprising carrier fluid 104 and cloaking fluid 106 at least partially surrounding carrier fluid 104, wherein the droplet is deposited onto surface 112 of substrate 110, and wherein cloaking fluid 106 is in contact with surface 112. FIG. 3A shows a non-limiting embodiment of the cloaking fluid in contact with the surface of the substrate after deposition of the composition. According to some embodiments, depending on the components of the composition, the properties of the composition, the composition of the substrate, and/or the rate of velocity at which the composition is deposited, the carrier fluid may be in contact with the surface of the substrate instead of or in addition to the cloaking fluid being in contact with the surface of the substrate. For example, FIG. 3B shows, according to certain embodiments, a cross-sectional schematic diagram of article 103b comprising a droplet comprising carrier fluid 104 and cloaking fluid 106 partially surrounding carrier fluid 104, wherein the droplet is deposited onto surface 112 of substrate 110, and wherein carrier fluid 104 is in contact with surface 112. FIG. 3C shows, according to certain embodiments, a cross-sectional schematic diagram of article 103c comprising a droplet comprising carrier fluid 104 and cloaking fluid 106 partially surrounding carrier fluid 104, wherein the droplet is deposited onto surface 112, and wherein both carrier fluid 104 and cloaking fluid 106 are in contact with surface 112.

Although FIGS. 3A-3C show that carrier fluid 104 includes species 108, as explained above, cloaking fluid 106 may include species 108 in addition to or instead of carrier fluid 104 including species 108, as the disclosure is not meant to be limiting in this regard.

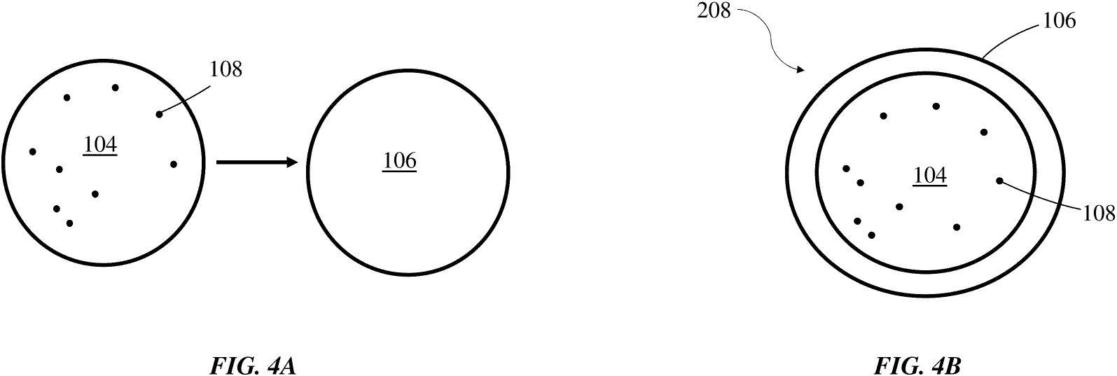

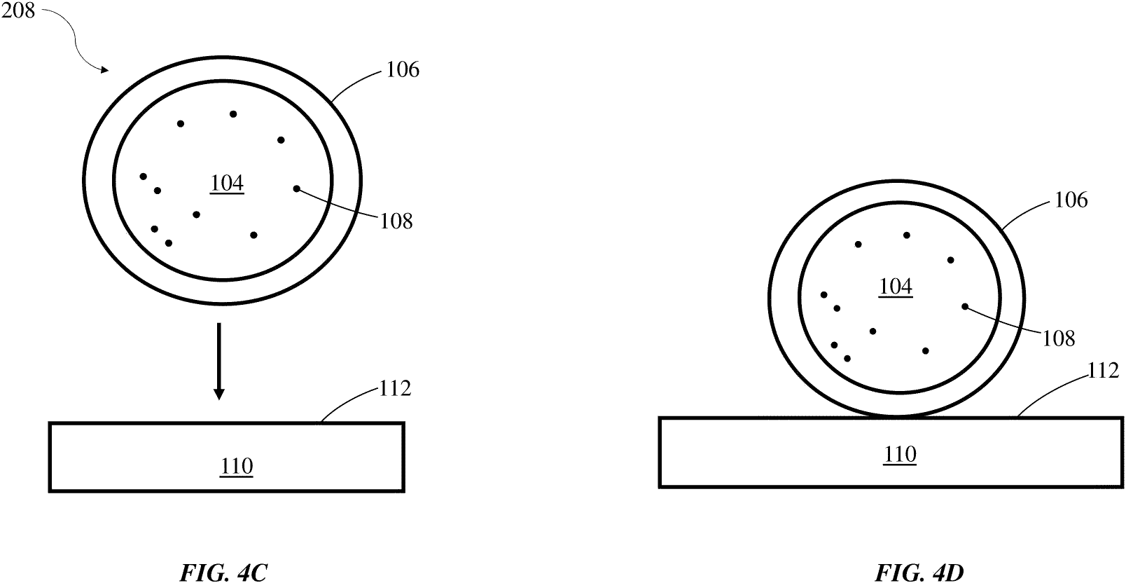

According to some embodiments, a method of depositing a droplet onto a surface of a substrate is described. FIGS. 4A-4D show, according to certain embodiments, a method of depositing a droplet onto a surface of a substrate. As shown in FIG. 4A, the method may, in some embodiments, comprise exposing carrier fluid 104 (e.g., including species 108) to cloaking fluid 106. Although FIG. 4A shows that carrier fluid 104 includes species 108, as explained above, in some embodiments cloaking fluid 106 may include species 108 in addition to or instead of carrier fluid 104 including species 108, as the disclosure is not meant to be limiting in this regard.

Referring to FIG. 4B, as a result of exposing carrier fluid 104 to cloaking fluid 106, cloaking fluid 106 may, in some embodiments, at least partially surround carrier fluid 104, thereby forming droplet 208. In certain embodiments, as shown in FIGS. 4C-4D, the method further comprises depositing droplet 208 on surface 112 of substrate 110. In some embodiments, the droplet may be formed in situ, such that the cloaking fluid at least partially surrounds the carrier fluid while the droplet is being deposited onto the surface of the substrate. FIG. 4D shows that cloaking fluid 106 is in contact with surface 112 of substrate 110, however the embodiment shown in FIG. 3B, wherein carrier fluid 104 is in contact with surface 112, or the embodiment shown in FIG. 3C, wherein both carrier fluid 104 and cloaking fluid 106 are in contact with surface 112, are also possible, as the disclosure is not meant to be limiting in this regard.

Any of a variety of suitable substrates may be employed. In certain embodiments, the substrate is an agricultural substrate. Examples of agricultural substrates include, but are not limited to, a plant or a portion of a plant. In certain embodiments, for example, the substrate may be a leaf (e.g., tree leaf, cabbage leaf, kale leaf, lettuce leaf, spinach leaf, and the like), stem, fruit, vegetable, flower, root, seed, nut, and/or the like. Other substrates are also possible. The surface of the substrate may, in certain embodiments, be at least partially hydrophobic (e.g., having a water contact angle greater than 90 degrees) or superhydrophobic (e.g., having a water contact angle greater than 150 degrees).

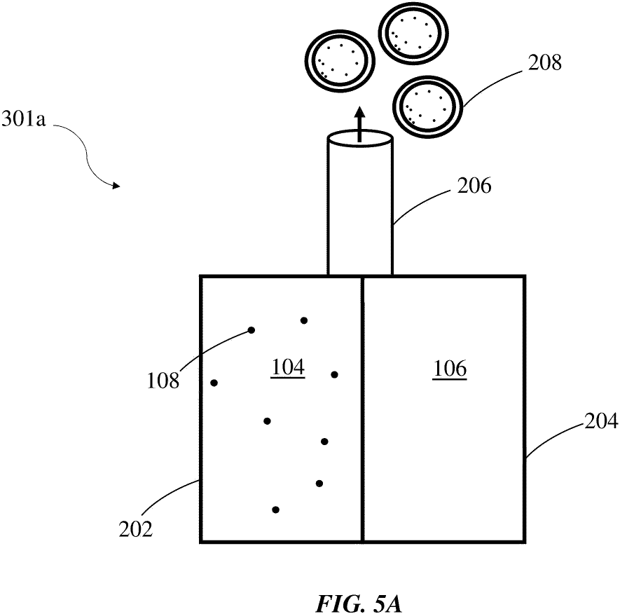

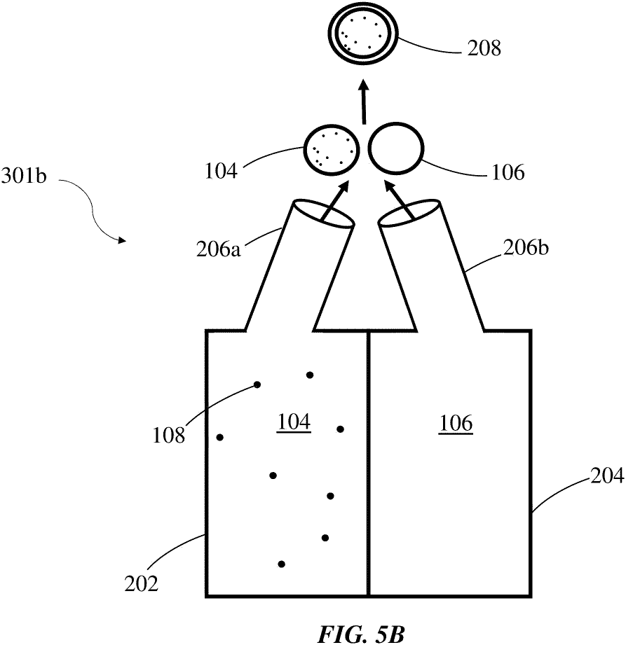

In certain embodiments, a device is described. FIG. 5A shows, according to certain embodiments, device 301a, which comprises nozzle 206 for delivering droplet 208 comprising a carrier fluid and a cloaking fluid at least partially surrounding the carrier fluid, wherein the carrier fluid includes a species. Device 301a may, in some embodiments, comprise first compartment 202 containing carrier fluid 104 and second component 204 containing cloaking fluid 106. In certain embodiments, the device comprises a species, which, as explained above, may be at least partially dissolved and/or suspended in the carrier fluid and/or the cloaking fluid. FIG. 5A shows that carrier fluid 104 includes species 108, but, as explained above, cloaking fluid 106 may include species 108 in addition to or instead of carrier fluid 104 including species 108, as the disclosure is not meant to be limiting in this regard.

In certain embodiments, although not shown in the figures, the species may be separate from the carrier fluid and the cloaking fluid, such that the species may be contained within a third compartment separate from the first compartment and the second compartment. In some such embodiments, the device may be configured to expose the species to the carrier fluid and/or the cloaking fluid via a nozzle, conduit, and/or channel fluidly connecting the first compartment and/or the second compartment to the third compartment.

In some embodiments wherein the composition comprises a plurality of cloaking fluids (e.g., a first cloaking fluid and a second cloaking fluid), the device may comprise additional compartments to contain the additional cloaking fluids.

According to some embodiments, the device is configured to expose the carrier fluid to the cloaking fluid such that the cloaking fluid at least partially surrounds the carrier fluid. For example, in certain embodiments the device comprises at least one nozzle. Referring, for example, to FIG. 5A, device 301a comprises nozzle 206, which may, in some embodiments, be configured to spray carrier fluid 104 and cloaking fluid 106 simultaneously such that droplet 208 is formed (e.g., in situ as the droplet is being applied to a surface). In certain embodiments, device 301a may be configured to deposit droplet 208 onto a surface of a substrate.

In other embodiments, the device may comprise two nozzles. FIG. 5B shows, according to certain embodiments, device 301b comprising first nozzle 206a and second nozzle 206b. According to certain embodiments, the two nozzles may be configured to expose carrier fluid 104 to cloaking fluid 106 such that cloaking fluid 106 at least partially surrounds carrier fluid 104, thereby generating droplet 208 comprising the carrier fluid and the cloaking fluid at least partially surrounding the carrier fluid, wherein the carrier fluid includes a species. In some such embodiments, first nozzle 206a is fluidly connected to first compartment 202 containing carrier fluid 104 (e.g., including species 108) and second nozzle 206b is fluidly connected to second compartment 204 containing cloaking fluid 106. As explained above, although FIG. 5B shows that carrier fluid 104 includes species 108, cloaking fluid 106 may include species 108 in addition to or instead of carrier fluid 104 including species 108, as the disclosure is not meant to be limiting in this regard. In certain embodiments, device 301b may be configured to deposit droplet 208 onto a surface of a substrate.

According to certain embodiments, although not shown in the figures, one or more compartments and/or one or more nozzles of the device may be associated with a pressure source. The pressure source may, in certain embodiments, pressurize the fluid (e.g., the carrier fluid, the cloaking fluid) within the one or more compartments and/or the one or more nozzles so that the fluid can be dispensed (e.g., sprayed) from the device (e.g., through the nozzle).

According to certain embodiments, the one or more nozzles of the device may be configured to spray the composition and/or components thereof (e.g., a carrier fluid, a cloaking fluid) at any of a variety of suitable velocities. In some embodiments, for example, the one or more nozzles of the device are configured to spray the composition and/or components thereof at a velocity greater than or equal to 1 m/s, greater than or equal to 2 m/s, greater than or equal to 3 m/s, greater than or equal to 4 m/s, greater than or equal to 5 m/s, greater than or equal to 6 m/s, greater than or equal to 7 m/s, greater than or equal to 8 m/s, greater than or equal to 9 m/s, greater than or equal to 10 m/s, or greater than or equal to 15 m/s. In certain embodiments, the one or more nozzles of the device are configured to spray the composition and/or components thereof at a velocity less than or equal to 20 m/s, less than or equal to 15 m/s, less than or equal to 10 m/s, less than or equal to 9 m/s, less than or equal to 8 m/s, less than or equal to 7 m/s, less than or equal to 6 m/s, less than or equal to 5 m/s, less than or equal to 4 m/s, less than or equal to 3 m/s, or less than or equal to 2 m/s. Combinations of the above recited ranges are possible (e.g., the one or more nozzles of the device are configured to spray the composition and/or components thereof at a velocity greater than or equal to 1 m/s and less than or equal to 20 m/s, the one or more nozzles of the device are configured to spray the composition and/or components thereof at a velocity greater than or equal to 5 m/s and less than or equal to 10 m/s). Other ranges are also possible.

The compositions, articles, methods, and/or devices described herein may be used for any of a variety of suitable applications. According to some embodiments, the composition may comprise an advantageously low amount of a cloaking fluid (e.g., oil) that enhances retention (e.g., spray retention) of the composition on a surface of the substrate, such as the surface of a portion of a plant, as compared to conventional compositions comprising, for example, only water, oil-in-water (O/W) emulsions, and/or water-in-oil (W/O) emulsions. In certain embodiments, for example, and as described herein, the composition may comprise one or more species (e.g., pesticides), and the composition may be configured to enhance the retention of the one or more species on a surface of a substrate (e.g., a portion of a plant).

The following examples are intended to illustrate certain embodiments of the present invention, but do not exemplify the full scope of the invention.

### EXAMPLE 1

The following example describes the use of minute quantities of a cloaking fluid to enhance spray retention of droplets on substrate surfaces.

Compound drop impacts have received increased interest over the past few years. However, water-in-oil compound droplet impacts have not been studied on superhydrophobic surfaces and at low concentrations of oil (e.g., ≤1% vol.). As explained in further detail below, by cloaking water droplets in plant oils, compound drops were made that stick to hydrophobic plant surfaces.

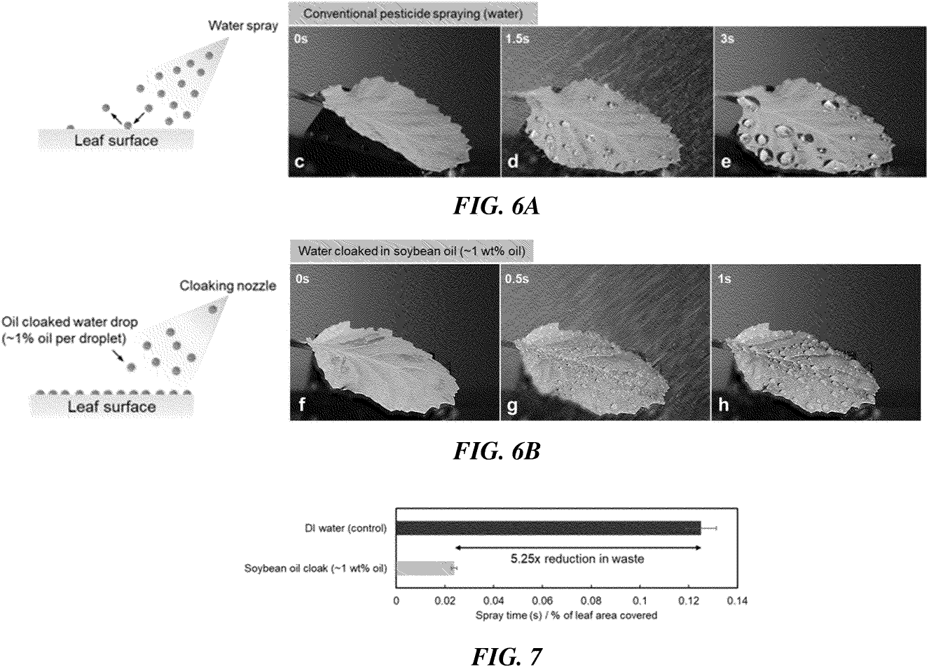

FIG. 6A shows time-lapse images of water droplets sprayed using an agricultural sprayer onto a cabbage leaf for 3 seconds. The nozzle in this case produced droplets with a volume median diameter between 341-403 µm at velocities between 5-10 m/s. Some droplets pinned wherever there were defects on the leaf, but a majority of the sprayed water bounced off, highlighting the problem of poor droplet retention in conventional agrochemical spraying. In contrast, FIG. 6B demonstrates the effectiveness of cloaking water drops with ~1% of soybean oil, a ubiquitous plant-based oil, which: (i) is used in food products; (ii) is approved by the Environmental Protection Agency (EPA) for agricultural use; (iii) has minimal impact on the environment; and (iv) is inexpensive. With a third of the spraying time, more uniform coverage was achieved. The ability of this approach to reduce pesticide waste was quantified by normalizing the spray time by the percentage of the leaf area covered with droplets. As shown in FIG. 7, it was found that oil-cloaking led to a 5.25x reduction in pesticide waste, indicating the great promise of this simple, inexpensive, and environmentally sustainable approach.

To fully understand this technique’s potential to enhance droplet retention, the technique was studied systematically with two types of nanoengineered superhydrophobic surfaces. Droplet impact dynamics were examined at a variety of agriculturally relevant spray velocities and Weber numbers and the effect of cloaking with different oils of varying surface tension and viscosity was systematically studied. The effect of oil fraction was explored, and a simple energy state framework is presented to explain the rebound suppression observed with oil cloaked droplets. A practical embodiment of this system was tested and significant improvements in spray retention on nanoengineered superhydrophobic surfaces and vegetable crop leaves is demonstrated.

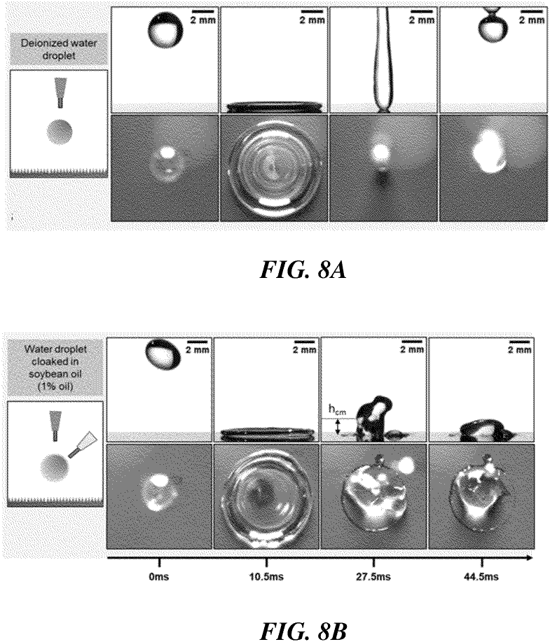

Single water droplets of different diameters were created by forcing liquids through needles of different gauges. The oil cloaks were applied using a secondary needle as shown in FIG. 8B. The flow rates of all fluids were controlled using syringe pumps. For oil fractions < 1% by volume, the stainless-steel needles were hydrophobized to prevent any wicking losses. The impact velocities were changed by controlling the release height of the dispensed droplets. Silicon nanograss surfaces were used as model superhydrophobic surfaces. The surfaces had an average texture size and spacing of around 200 nm and were functionalized with different hydrophobic modifiers. The advancing and receding contact angles of DI water on this substrate were 163.9° and 159.3°, respectively, on the octadecyltrichlorosilane (OTS) coated surfaces and 166.6° and 164.8°, respectively, on the trichloro(1h,1h,2h,2h-perfluorooctyl)silane (FS) coated surfaces. The impact experiments were observed using a Photron Fastcam SA1.1 high speed camera.

FIG. 8A shows time-lapse images of a water droplet (diameter ≈ 3 mm and impact speed ≈ 1.25 m/s) impacting on an OTS-Nanograss surface from the side (top) and top-down (bottom) views. The droplet behaved as expected, going through a symmetric retraction phase and completely rebounding from the surface. FIG. 8B shows impacts under identical conditions (velocity and diameter) with droplets that were cloaked in 1% soybean oil by volume. While the expansion phase was nearly identical in terms of the maximum diameter and the expansion time, the retraction phase in the cloaked case was markedly different. During retraction, the droplet’s contact line was pinned to the surface due to the oil. This significantly reduced the retraction speed and caused the droplet to stick to the surface. The setup tracks the maximum height of the droplet’s center of mass (h_{cm}), offering a quantitative measurement to track rebound suppression. Illustratively, h_{cm} is labeled in FIG. 8B. To confirm that the spreading phase of the impacts were undisturbed, and to study the dynamics of rebound suppression more thoroughly, drop impact experiments with 9 different oils of varying viscosities and surface tensions were conducted.

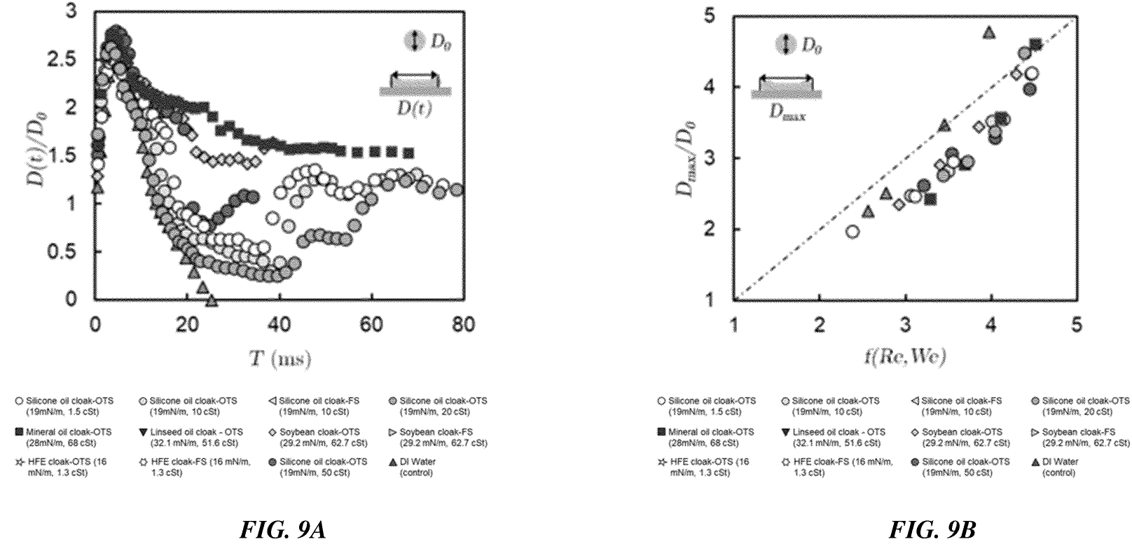

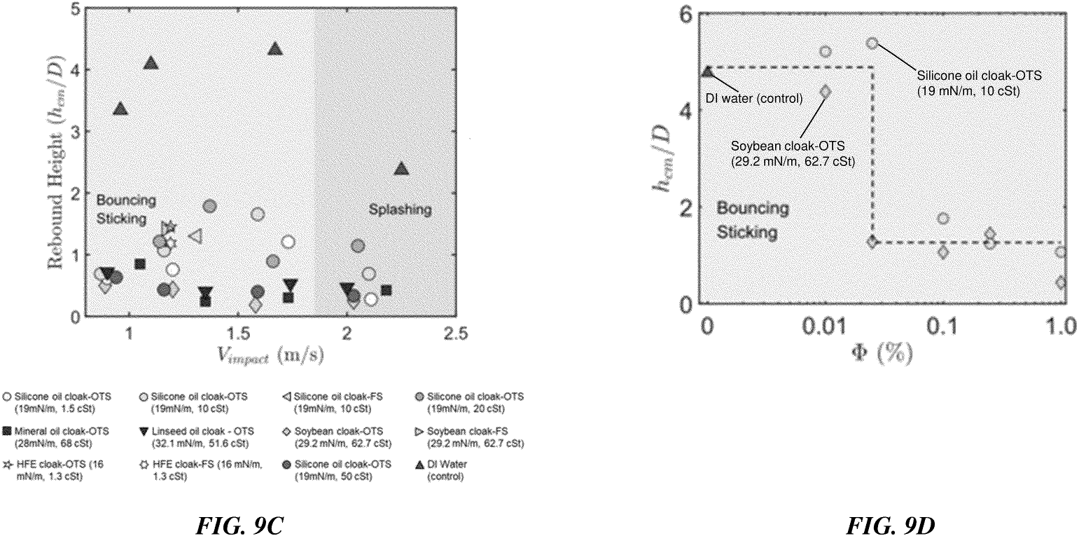

FIG. 9A shows the time evolution of the contact diameter of droplets (D(t)) normalized by their initial diameter D₀ for 6 representative oil cloaking conditions. These experiments were all conducted at 1% oil fraction by volume and at an impact velocity of ≈1.25 m/s on OTS-coated nanograss surfaces. Only the control DI water droplet lost contact with the surface after rebound under these conditions as all the oil cloaks were successful in suppressing rebound. The observations in FIGS. 8A-8B were further confirmed, as the expansion phase was approximately identical in terms of maximum droplet diameter and the expansion time for all the droplets. During the retraction phase the contact lines of the cloaked droplets began to pin to the surface. FIG. 9B shows the normalized maximum diameter for impact experiments with different oil cloaks, droplet sizes, and impact velocities. The Weber numbers of the droplets were varied from 45-639 and the Reynolds numbers from 1972-7875 to span agriculturally relevant conditions. For this regime, the normalized maximum diameter at full expansion scales is shown in equation 1:

$${D}_{max} / {D}_{0} = f \left(Re , W e\right) = \frac{W {e}^{\frac{1}{2}}}{1.24 + W {e}^{\frac{1}{2}} {R}_{e} {}^{- \frac{1}{5}}}$$

where We is the Weber number and Re is the Reynolds number. Once again, it was observed that the maximum diameters were nearly identical for cases with and without oil cloaks and followed the trend indicated by equation 1. This demonstrates that the expansion phase of the droplet impacts is largely unaffected by the presence of an oil cloak at a variety of impact velocities and for different oils.

The maximum height the droplet’s center of mass (h_{cm}), as defined earlier, was revisited to focus attention on the retraction phase and the rebound behavior of cloaked droplets. Using highspeed videos of the droplet impacts, h_{cm} of the droplets was measured and normalized by the initial droplet diameter D₀. FIG. 9C plots the normalized rebound height for various impact velocities, oil cloaking conditions, and surfaces. In these experiments, the oil fraction was kept constant at 1% by volume for the cloaked droplets. The plot demonstrates the robustness of the approach in promoting droplet retention. Regardless of the type of the oil, the oil viscosity, or oil surface tension, the cases with cloaking led to droplets sticking on superhydrophobic surfaces for velocities from 0.8-2.3 m/s, which corresponds to the agriculturally relevant We numbers of 81-646. Oil viscosities were varied between 1.3 cst and 68 cst. The surface tensions of the oil were varied between 16 mN/m to 32 mN/m.

A general trend of lower h_{cm} for higher surface tensions and viscosities was observed in these experiments. At the higher end of the impact velocities, splashing of both the DI water droplets and the oil cloaked droplets was observed. Interestingly, while the satellite droplets in the control case scattered off the surface, nearly all the satellite droplets in the oil-cloaked case adhered to the surface. Typically, smaller droplet sizes that are more prone to drift are chosen to enhance coverage on plant surfaces, but these results indicate that the methodology could enable the use of large droplets that are resistant to drift while still benefiting from enhanced coverage afforded by satellite droplets.

FIG. 9D demonstrates the effect of the oil fraction for two representative oils of low and high viscosity. Both oils were effective at preventing retention at 0.1% by volume, furthering the practical robustness of the approach. This volume of oil is comparable to the total amount of adjuvants used in conventional agricultural spraying, including when oil-in-water emulsions are employed.

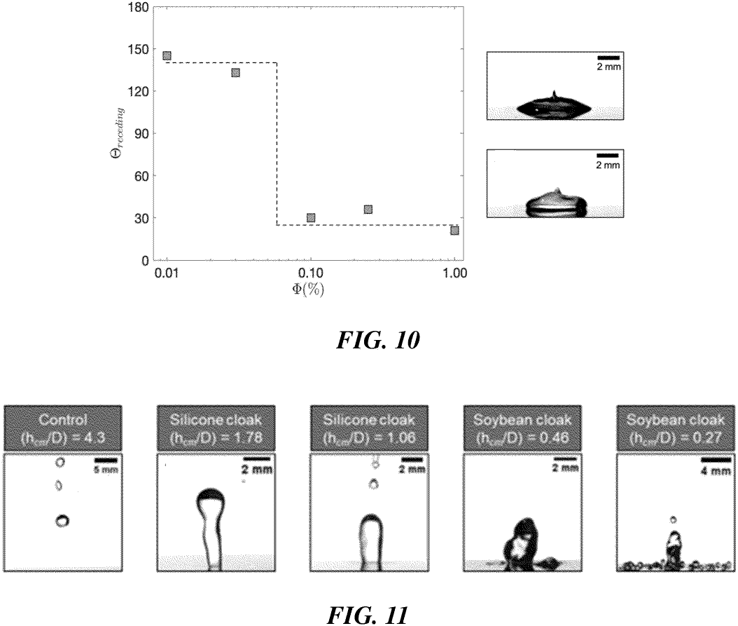

FIG. 10 indicates some of the complexities that arise at lower oil fractions. As the volume fraction reaches 0.1%, it was noticed that the rim of oil that pins the droplet became discontinuous. This rim subsequently disappeared as the oil fractions go below 0.1%. At these volume fractions, the average contact angle during the retraction phase also changed drastically from about 30° to about 140°. At 0.01% volume fraction, the retraction phase was comparable to that of a DI water droplet, indicating that there is a minimum amount of oil needed for the approach to be effective. FIG. 11 shows some examples of the maximum normalized rebound height for different impact conditions to highlight the distinction between the bouncing, sticking, and splashing regimes.

It has been demonstrated that oil-cloaking offers a simple yet robust approach to enhance droplet retention on superhydrophobic surfaces over a range of agriculturally relevant impact conditions, for a wide range of oils, oil viscosities, and oil volume fractions. However, it is also clear from these impacts that the mechanisms that govern retraction dynamics are fairly complex. There are several macroscopic and microscopic pinning events that lead to energy loss during retraction. Highspeed videos indicated the formation of a rim of oil plays a role in pinning the droplets to the surface. However, it is also evident that the thickness, continuity, and symmetry of the rims are highly variable. An added complication arises when the volume fraction of the oil goes down below 0.1%. In this case, oil scarcity at the interface needs to be considered in any model that attempts to accurately capture the dynamics of these compound droplet impacts. While explaining the explicit dynamics of this system will require more examination of the fluidic and interfacial interactions at play, a simple analysis of energy states can be used to explain droplet retention.

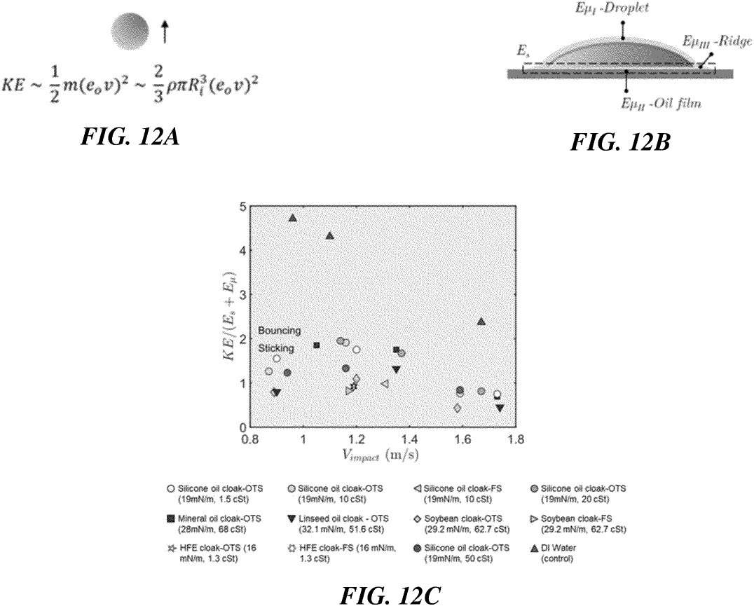

An impacting droplet can be considered in two states: (i) at the maximum diameter during impact; and (ii) after the droplet has rebounded. Focusing first on the latter state, when a water droplet rebounds off a superhydrophobic surface, its kinetic energy can be expressed as a product of its incoming kinetic energy and the coefficient of restitution (e₀), which is shown in FIG. 12A. In the case of water droplets, the coefficient of restitution on a superhydrophobic surface is a function of the Weber number. Using this trend, for any water droplet of a given size and incoming velocity, one can estimate the rebound kinetic energy that the droplet would carry. For any technique to suppress this rebound, this energy would have to be removed from the droplet. Returning to the other state of interest-when the droplet reaches its maximum diameter, two types of energy dissipation mechanisms can be considered, one due to surface tension and another due to viscosity.

The work of adhesion (Eₛ), the term that captures the amount of work needed to remove a droplet from a surface, can be written in terms of the surface tension of the fluid in contact with the surface (σₒᵤₜₑᵣ), the receding contact angle of the droplet (θᵣ), and the maximum radius of the droplet on the surface (Rₘₐₓ) as shown in equation 2:

$${E}_{S} \sim {σ}_{o} \left(1 + cos \left({θ}_{r}\right)\right) π {R}_{max}^{2}$$

In the cloaked cases, it was assumed that the entire contact area with the surface was covered by oil during the impact event. This is a reasonable assumption given the fact that the oil is preferentially wetting on the surface compared to water. The second dissipation mechanism is only present in the oil cloaked cases and is due to the viscosity of the oil cloak itself. The viscous dissipation E_{µ} can be expressed as a sum of three terms, dissipation of the oil cap (Eµ_{I}), dissipation in the oil film underneath the droplet (Eµ_{II}) and dissipation in the oil ridge (Eµ_{III}), as shown in FIG. 12B and equations 3-5:

$${Ε}_{μ} \sim Ε {μ}_{I} + Ε {μ}_{I I} + Ε {μ}_{I I I}$$

$${E}_{μ} \sim {μ}_{w} {U}_{r}^{2} {R}_{max} + \frac{{μ}_{w}^{2}}{{μ}_{o}} {μ}_{0} {U}_{r}^{2} t + {μ}_{o} {U}_{r}^{2} {R}_{max}$$

$${Ε}_{μ} \sim {μ}_{o} {U}_{r}^{2} {R}_{max}$$

Comparing the relative magnitude of these terms, it was seen that the viscous dissipation in the oil ridge at the contact line of the receding droplet would be the dominant term. It is noted that the dissipation in the water drop does not need to be considered in this energy balance as it is already accounted for in the coefficient of restitution. Using this framework, if the sum of the work of adhesion and the viscous dissipation scales with the rebound kinetic energy, the droplet will stick, and if the rebound kinetic energy is much greater than the sum of these terms, the droplet should bounce.

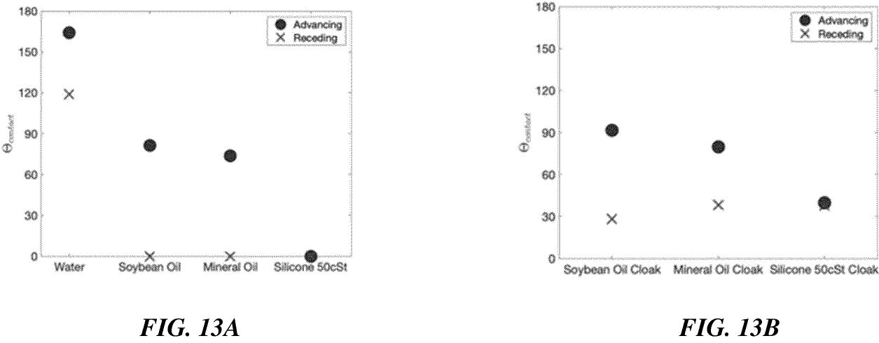

FIG. 12C plots the rebound kinetic energy normalized by the sum of the work of adhesion and the viscous dissipation for each experimental condition that the model is applicable to. For each droplet, the rebound kinetic energy that would be carried by a water droplet of similar size and incoming velocity was estimated using the coefficient of restitution. The work of adhesion and the viscous dissipation were estimated using the maximum contact diameter observed during each droplet impact. The contact angle used in this case is the quasi-static receding angle of the compound droplets on the superhydrophobic surface as reported in FIGS. 13A-13B. Given these clarifications, it was seen that the sum of the work of adhesion and viscous dissipation scales well with the rebound kinetic energy for all the oil cloaked droplets, illustrating why they are able to stick. In contrast, the pure water droplets (which are the only experiments in which the droplet rebounded) have kinetic energies that are approximately 3x larger than the sum of the dissipative terms.

Given that the energy dissipation model is able to capture the rebound behavior of droplets accurately, it is worth commenting on higher viscosities and the effect of the cloaking timescale. The impact of a droplet cloaked in 500 cSt silicone oil with a 1% oil volume fraction was observed via highspeed video. While this high viscosity oil slightly effected the retraction phase, as compared to the pure water case, it was much less effective at suppressing rebound than the other cases of cloaked droplets where the oil viscosity was less than 70 cSt. This experiment with a high viscosity oil thus provided some insight into cloaking timescales and its importance in rebound suppression. Indeed, the simple energy state model presented above would have predicted that the droplet would stick provided all other assumptions held. However, cloaking timescales of oils of different viscosities on water drops suggest that the assumption of the oil covering the entire interfacial area would not hold in this case of cloaking with a highly viscous oil. Specifically, all of the other oils that were used in the study have viscosities < 70 cSt, suggesting that they should be able to cloak the water drops and the interface between the droplet and the superhydrophobic surface (SHS) as well due to their low viscosity in about 0.5 ms. In contrast, the high viscosity oil would take about 50 ms to cover the entire droplet and around tens of milliseconds to cloak the interfacial area between the droplet and the SHS. Given that the entire retraction phase occurs in about 10-20 ms, this might not be enough time for a highly viscous oil to be able to suppress rebound.

Having explored a wide regime of fluidic and interfacial parameters with single droplet impacts, a practical device was implemented that could be used to demonstrate practical enhancements to spray retention. A prototype that involved two nozzles, one for the water and another for the oil, was developed.

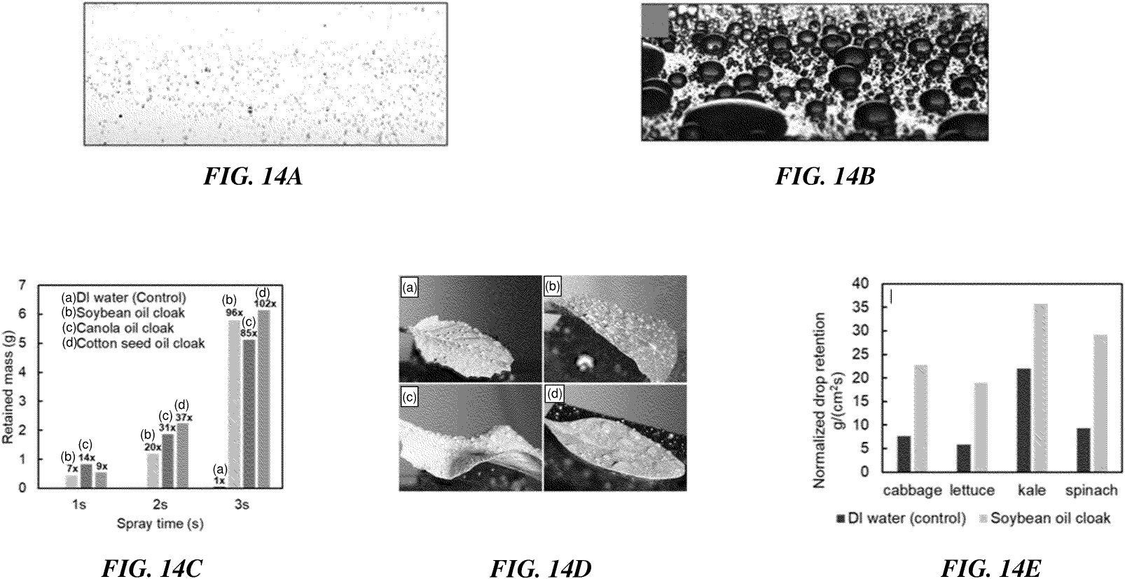

To test the ability of the sprayer device to enhance retention in the most extreme case, both water and soybean oil-cloaked water droplets were sprayed onto a large OTS-nanograss surface. In order to measure retention performance in terms of mass, the retained mass of droplets was weighed in both cases. FIG. 14A shows a photograph of the result of spraying water drops onto the surface for 3 seconds. As expected, almost all the water drops sprayed onto the superhydrophobic surface bounce off. FIG. 14B shows a photograph of the result of spraying water drops cloaked in ~ 1 wt.% soybean oil for 3 seconds. Almost immediately after spraying commences, the water drops begin sticking to the surface and by the end of 3 seconds, a 96x enhancement in retained mass was measured (FIG. 14C) for the case of soybean oil. FIG. 14C also shows retention data for experiments where oil cloaked droplets were only sprayed for 1 and 2 seconds. It was found that this trend is consistent for other vegetable oils that are commonly used in agriculture such as canola or cotton seed oil, illustrating the robustness of the approach. These experiments show the potential of this technology to greatly reduce the amount of pesticides sprayed, as with even a third of the spray time, the technique allows for 7.3x-14x enhancements in mass retention based on the oil used. Crucially, these enhancements are achieved with oils that are inexpensive, widely used, and safe for the environment, farm workers, and crops. These oils are also known to be widely compatible with pesticide chemistries, delay evaporation of agrochemical spray droplets, and promote foliar uptake of pesticides.

In FIGS. 6A-7, the ability of the prototype device sprayer to reduce spray waste in terms of surface coverage on leaves was demonstrated. To demonstrate the ability of the sprayer device to enhance the retained mass, three more crop leaves (kale, spinach and lettuce) were sprayed and the result of 1 s of spraying on all the leaves is shown in FIG. 14D. The total retained mass of droplets is normalized by the area of the leaf and the spraying time for both water and soybean oil cloaked droplets and is presented in FIG. 14E. A >3x enhancement in normalized retained mass across leaves was observed, demonstrating the wide practical applicability of the approach in enhancing droplet retention.

In conclusion, a simple, environmentally sustainable, inexpensive, and effective approach to enhance the retention of sprays on hydrophobic and superhydrophobic surfaces has been demonstrated. By cloaking droplets in minute quantities of oil (<1% by volume), robust rebound suppression on two types of superhydrophobic surfaces with 9 different oils that span a wide range of viscosities and surface tensions across agriculturally relevant impact conditions has been demonstrated. Rebound suppression with as little as 0.1% oil by volume per droplet was also demonstrated. By modeling the viscous and surface energy-based dissipation during the impacts of these cloaked droplets, a physical understanding of the rebound suppression was provided. Finally, these findings were translated into a prototype sprayer device which was able to demonstrate up to a 102x enhancement in retention on superhydrophobic surfaces and up to a 5.25x reduction in waste when spraying on crop leaves. These enhancements were achieved using food and environmentally safe vegetable oils, and the methodology presented demonstrates great promise in reducing the human health and environmental impact of pesticides.

Impact velocity, center of mass, and coefficient of restitution estimation: Impact velocity and Center of Mass (COM) data was extracted from the high-speed videos via image analysis of each frame. Care was taken when lighting the background and surface such that the edges of the droplet were the darkest features of the video. This enabled the use of a simple thresholding method to create a mask of the droplet’s outline. For each row of pixels in the droplet mask, the width of the mask was taken to be the local diameter of the droplet under the assumption that the droplet remained axisymmetric at all times. The partial mass of each row was calculated as the mass of a disk one pixel thick. The mass-average of these partial masses weighted by their vertical position yielded the COM. The impact velocity was calculated by differentiating the frame-by-frame vertical COM with respect to time and taking the velocity just before impact. Because the rebound velocity of a droplet is highly variable throughout the rebound process, an alternative definition of the coefficient of restitution was established, where eₒ =

$$\frac{\sqrt{2 g {h}_{C O M}}}{{V}_{i}} .$$

By using the maximum COM height of the droplet after rebound to calculate an equivalent velocity, a much more reliable value is obtained.

Practical embodiment setup: In order to test the coverage of leaf surfaces by an agriculturally relevant spray, a reservoir of deionized water was pressurized at 2 atm (30 psi) and flowed through a TG-1 TeeJet Full Cone Spray Tip (Spray Smarter), with the resulting spray directed at the leaf. A distance of approximately 75 cm was maintained between the sprayer and leaf. An AA250AUH Automatic Spray Nozzle (Spraying Systems) was installed just upstream of the spray tip to control the spray time by switching on and off. The water droplets from the primary nozzle were cloaked in oils using a secondary airbrush sprayer. Care was taken to ensure that the overlap angle of the two nozzles ensured that none of the oil from the secondary sprayer contaminated the surfaces directly. The flow rates of both fluids were controlled to ensure 1 wt.% cloaking.

Hydrophobizing needles: The stainless-steel needles were hydrophobized by submerging them for 24 hours in a solution of 5 mM fluoroalkyl(C10) phosphonic acid (SP-06-003, obtained from Specific Polymers) solvated in methanol. A flat stainless-steel control surface subjected to the same conditions had a water-air contact angle of >90° confirming successful hydrophobization.

Contact angle measurements: Contact angles were measured using a Ramé-Hart contact angle goniometer.

Confirming low volume fractions of oil: All the volume fractions of oil were confirmed by measuring the weights of dispensed liquids over time.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition comprising:
a carrier fluid;
a cloaking fluid; and
one or more species for delivery to a surface of a substrate,
wherein the cloaking fluid is configured to at least partially surround the carrier fluid while the composition is applied to the surface of the substrate.

2. A composition comprising:
a carrier fluid;
a cloaking fluid surrounding the carrier fluid; and
one or more species for delivery to a surface of a substrate,
wherein a spreading coefficient of the composition is greater than or equal to 0, wherein the spreading coefficient is defined by:
$$S = {σ}_{w a t e r + s p e c i e s , a i r} - \left({σ}_{w a t e r + s p e c i e s , c l o a k i n g f l u i d} + {σ}_{c l o a k i n g f l u i d , a i r}\right) ,$$
wherein σ is an interfacial tension.

3. A composition comprising:
a carrier fluid;
a cloaking fluid at least partially surrounding the carrier fluid; and
one or more species for delivery to a surface of a substrate,
wherein the composition comprises the cloaking fluid in an amount less than or equal to 5% by volume versus the total volume of the composition.

4. An article comprising:
a substrate comprising a surface; and
a droplet deposited on the surface, wherein the droplet comprises a carrier fluid, a cloaking fluid at least partially surrounding the carrier fluid, and one or more species for delivery to the surface of the substrate.

5. A method of depositing a droplet on a surface of a substrate, comprising:
exposing a carrier fluid to a cloaking fluid;
at least partially surrounding the carrier fluid in the cloaking fluid, thereby forming the droplet, wherein the droplet comprises the cloaking fluid in an amount less than or equal to 5% by volume versus the total volume of the droplet, and the droplet comprises one or more species for delivery to the surface of the substrate; and
depositing the droplet on the surface of the substrate.

6. A device comprising:
a first compartment containing a carrier fluid;
a second compartment containing a cloaking fluid; and
one or more species for delivery to a surface of a substrate,
wherein the device is configured to expose the carrier fluid to the cloaking fluid such that the cloaking fluid at least partially surrounds the carrier fluid, thereby providing a composition comprising the cloaking fluid in an amount less than or equal to 5% by volume versus the total volume of the composition.

7. The composition of claim 1, wherein the carrier fluid comprises water, an aqueous solution, an oil, and/or a non-Newtonian fluid.

8. The composition of claim 1, wherein the cloaking fluid comprises an oil, a surfactant, an aqueous solution, and/or a non-Newtonian fluid.

9. The composition of claim 8, wherein the oil is a plant-based oil and/or a petroleum-based oil.

10. The composition of claim 8, wherein the oil is soybean oil, canola oil, silicone oil, mineral oil, linseed oil, cotton seed oil, anise oil, bergamot oil, castor oil, cedarwood oil, citronella oil, eucalyptus oil, jojoba oil, lavandin oil, lemongrass oil, methyl salicylate oil, mint oil, mustard oil, and/or orange oil.

11. The composition of claim 1, wherein the one or more species is at least partially dissolved and/or suspended in the carrier fluid.

12. The composition of claim 1, wherein the one or more species is at least partially dissolved and/or suspended in the cloaking fluid.

13. The composition of claim 1, wherein the substrate is an agricultural substrate.

14. The composition of claim 13, wherein the agricultural substrate is a plant or a portion of a plant.

15. The composition of claim 1, wherein the surface is at least partially hydrophobic.

16. The device of claim 6, wherein the device comprises at least one nozzle.

17. The device of claim 16, wherein the at least one nozzle is configured to spray the composition.

18. The device of claim 16, wherein the at least one nozzle is configured to expose the carrier fluid to the cloaking fluid.

19. The composition of claim 1, wherein a spreading coefficient of the composition is greater than or equal to 0, wherein the spreading coefficient is defined by:
$$S = {σ}_{w a t e r + s p e c i e s , a i r} - \left({σ}_{w a t e r + s p e c i e s , c l o a k i n g f l u i d} + {σ}_{c l o a k i n g f l u i d , a i r}\right) ,$$
wherein σ is an interfacial tension.

20. The composition of claim 1, wherein the composition comprises the cloaking fluid in an amount less than or equal to 5% by volume versus the total volume of the composition.

21. The composition of claim 1, wherein the composition comprises the cloaking fluid in an amount less than or equal to 1% by volume versus the total volume of the composition.

22-24. (canceled)
